(19) United States
(12) Patent Application Publication
(10) Pub. No.: US 2019/0104842 A1
(43) Pub. Date: Apr. 11, 2019

(54) MODULAR FURNITURE CONSTRUCTION SYSTEM

(71) Applicant: Zekeazoid Arts & Entertainment LLC, San Jose, CA (US)

(72) Inventor: Jared Ezekiel Forman, San Jose, CA (US)

(73) Assignee: Zekeazoid Arts & Entertainment LLC, San Jose, CA (US)

(21) Appl. No.: 15/729,088

(22) Filed: Oct. 10, 2017

(51) Int. Cl. A47B 3/06; H05B 37/02; A47B 85/06; A47B 85/04; A47C 13/00

(52) U.S. Cl. CPC A47B 3/063; H05B 37/0227; A47C 13/005; A47B 85/06; A47B 85/04; H05B 37/0272

(57) ABSTRACT

A modular furniture construction set comprising multiple pieces that can be assembled in multiple ways to form temporary but stable forms that can be used for a variety of uses such as furniture, play structures, work surfaces, room partitions etc. With suitable dimensions and materials, it is conceivable that the present invention can be used to construct temporary or permanent housing. The assembled pieces are devised such that at least one embodiment of a completed assembly is a square cube.

### FIELD

The present invention pertains to a novel furniture construction system.

### BACKGROUND

Conventional furniture is typically bulky and designed for a specific function. For example, a chair, has a characteristic base surface with legs extending there beneath which is ideal for sitting. However, many people desire an artistic space-saving approach to furnish their living area. Therefore, a need exists for a construction system which allows one to design their own furniture arrangements to meet their personal preferences. The present invention addresses this need.

### BRIEF DESCRIPTION

To facilitate understanding, identical reference numerals have been used, where possible, to designate identical elements that are common to the drawings. The drawings are not to scale and the relative dimensions of various elements in the drawings are depicted schematically. The techniques of the present invention may readily be understood by considering the following detailed description in conjunction with the accompanying drawings, in which:

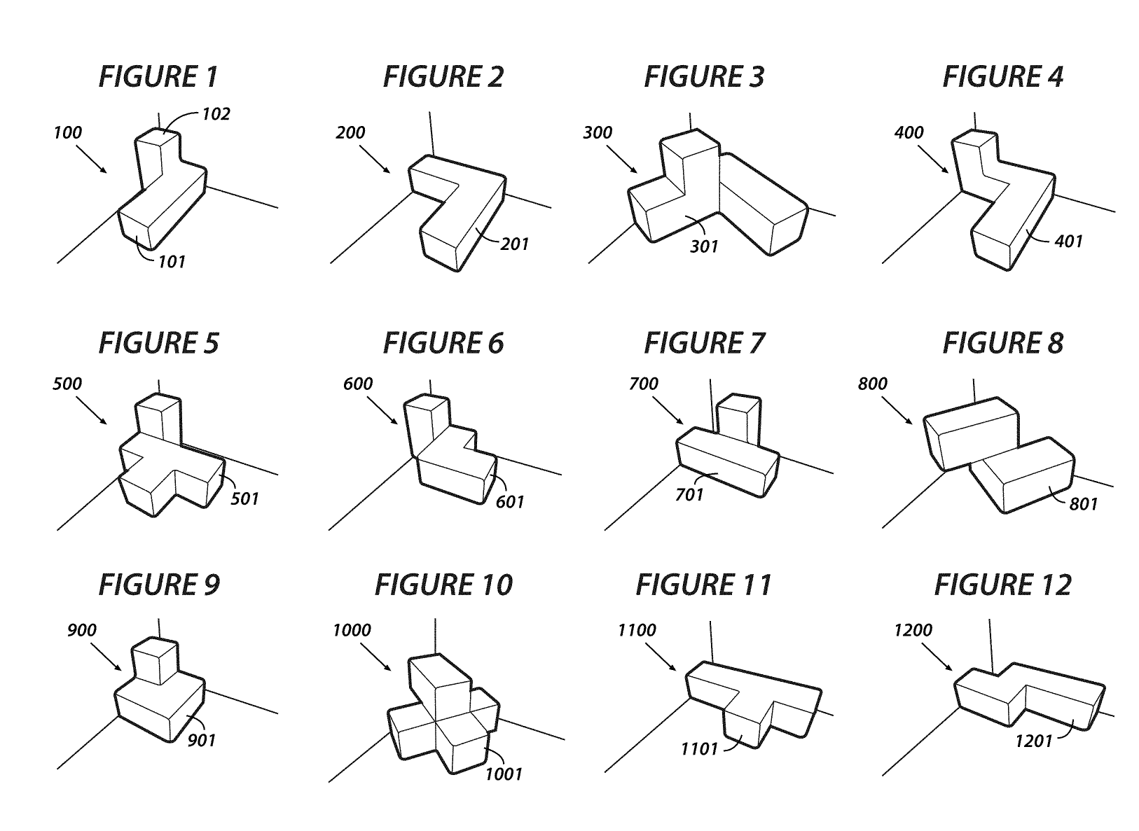

FIGS. 1-12 are exemplary polyblocks which may be utilized to construct various objects.

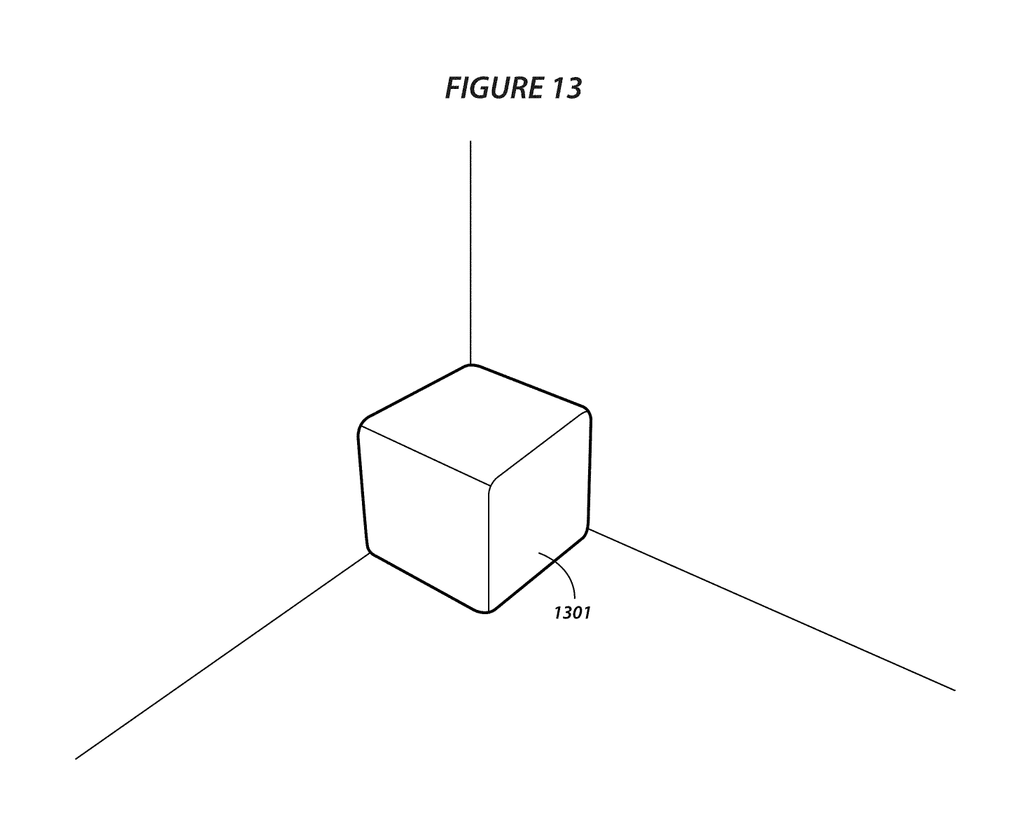

FIG. 13 is an exemplary cubic element of which each polyblock is equally divisible by according to some embodiments of the present invention.

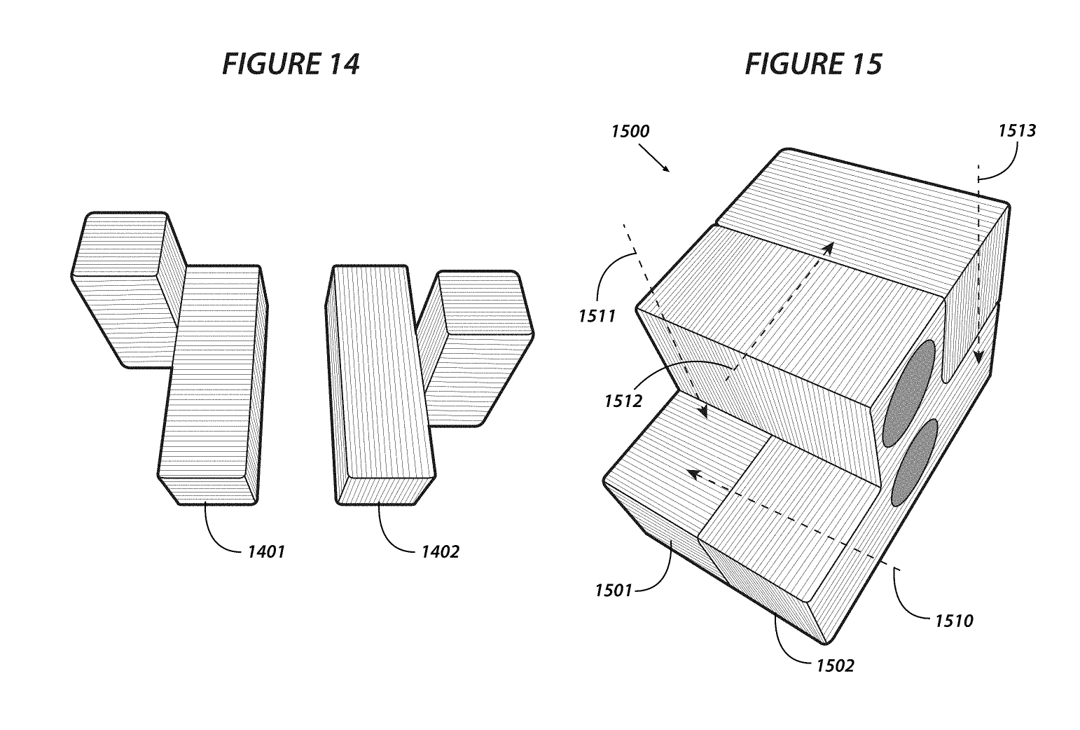

FIG. 14 illustrates exemplary polyblocks with light elements that can be assembled in a fashion to portray a specific lighting scheme as displayed in FIG. 15.

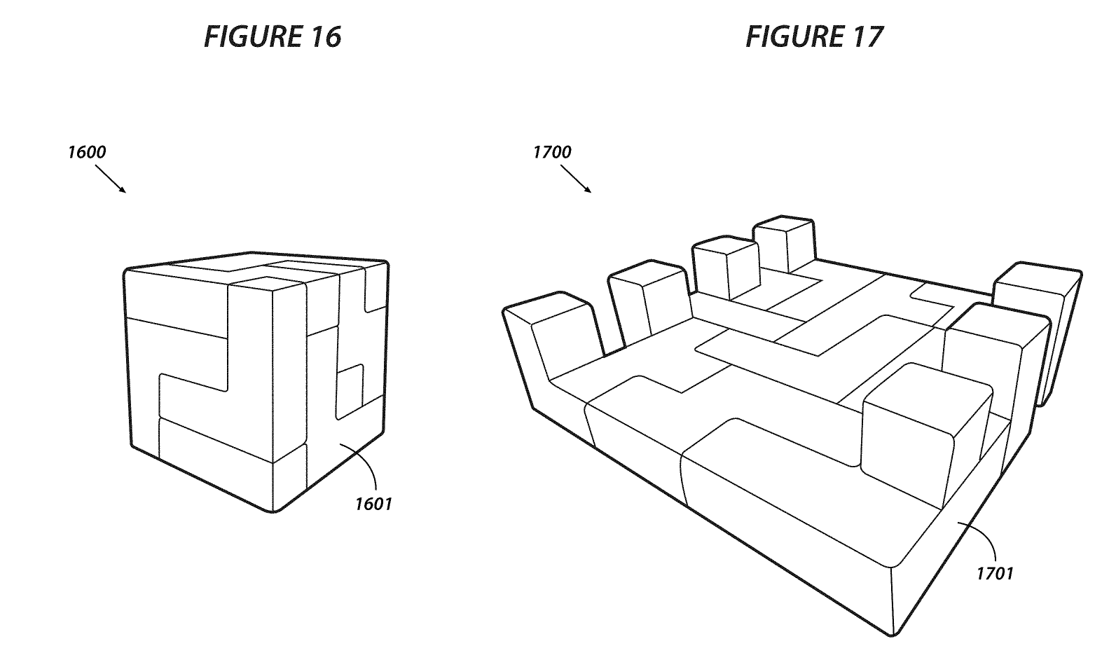

FIG. 16 is a constructed square assembly comprising all of the exemplary polyblocks depicted in FIGS. 1-12.

FIG. 17 is an exemplary bed constructed from several polyblocks depicted in FIGS. 1-12.

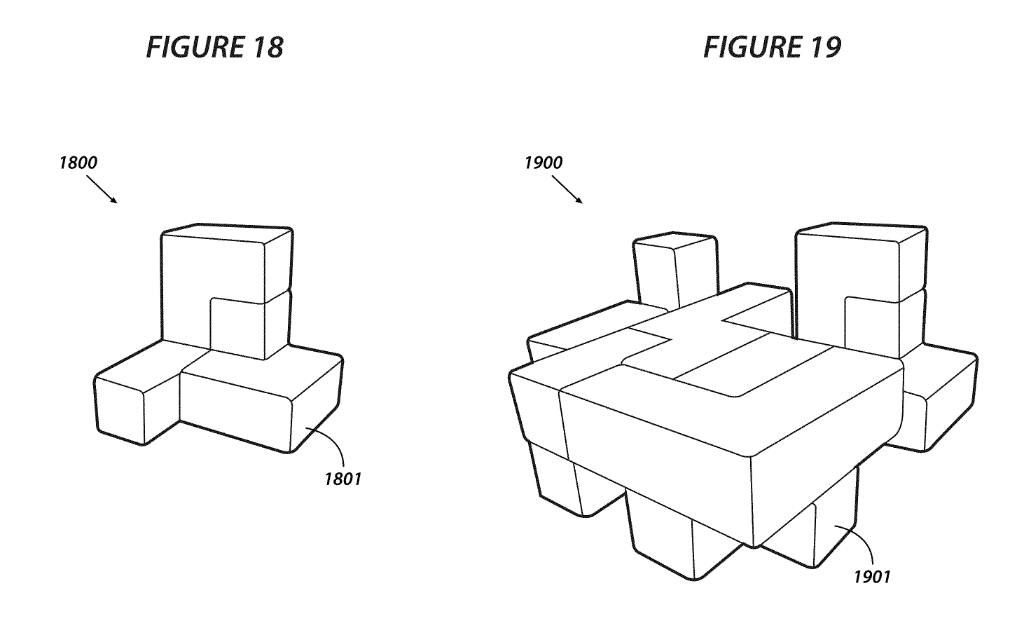

FIG. 18 is an exemplary chair constructed from two of the polyblocks depicted in FIGS. 1-12.

FIG. 19 is an exemplary table constructed from several polyblocks depicted in FIGS. 1-12.

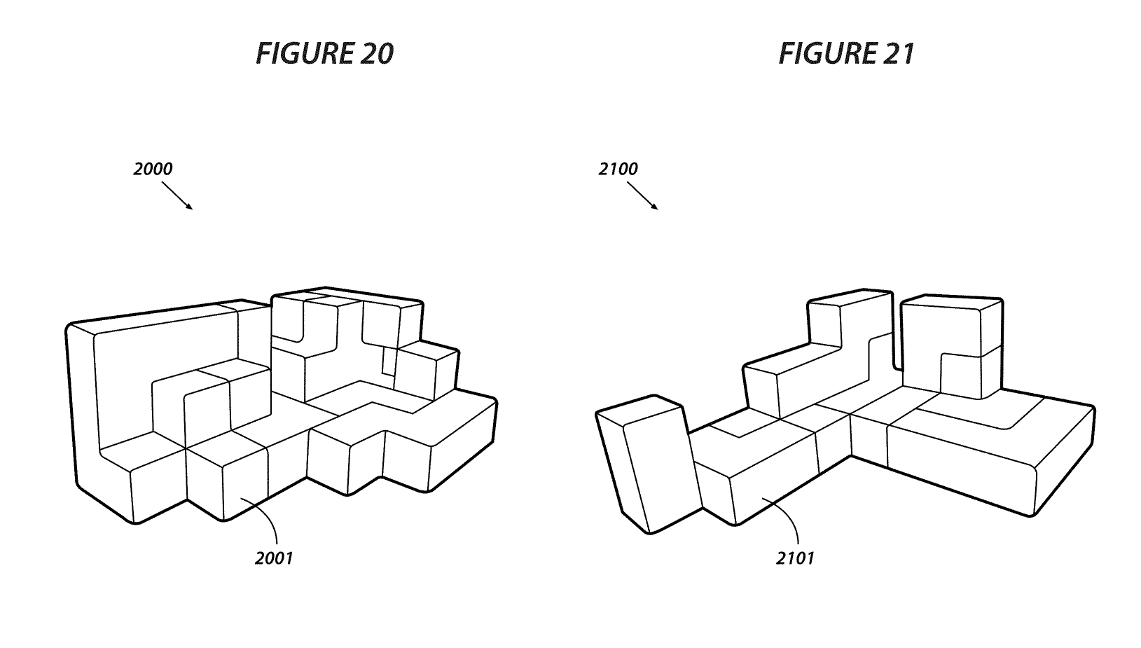

FIG. 20 is an exemplary couch constructed from several polyblocks depicted in FIGS. 1-12.

FIG. 21 is an exemplary lounge or reclining couch constructed from several polyblocks depicted in FIGS. 1-12.

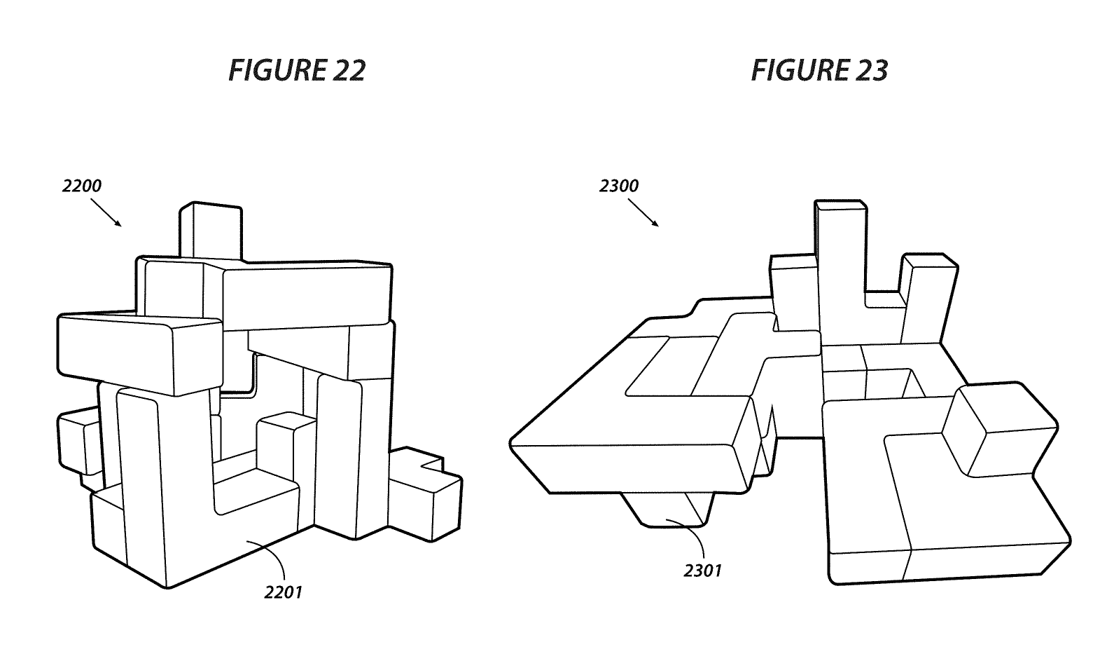

FIG. 22 is an exemplary play structure constructed from several polyblocks depicted in FIGS. 1-12.

FIG. 23 is an exemplary hybrid table constructed from several polyblocks depicted in FIGS. 1-12.

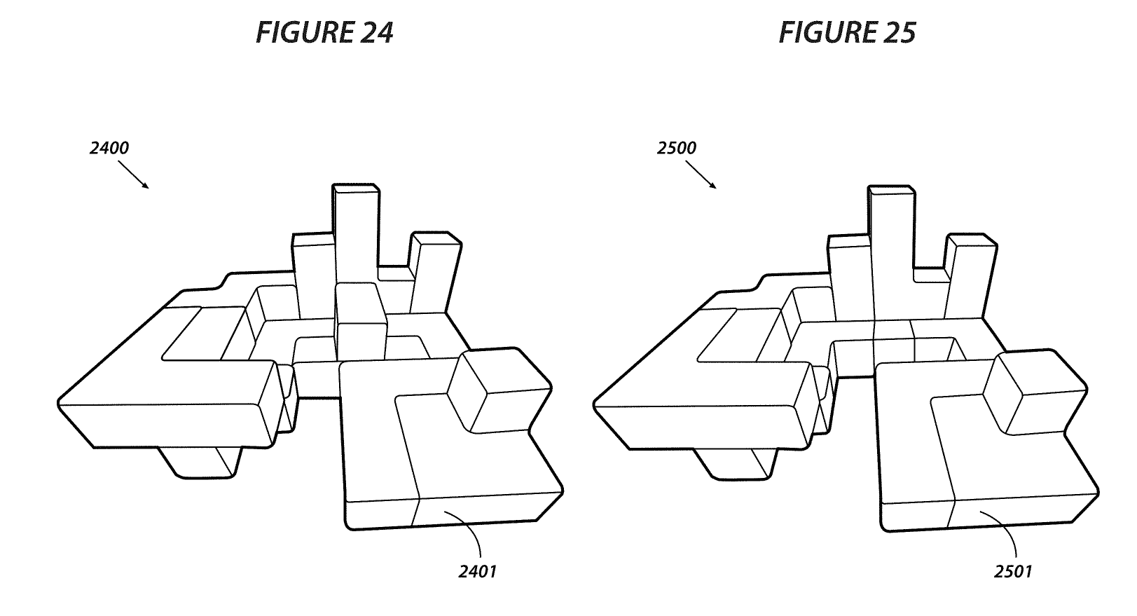

FIG. 24 is an exemplary hybrid furniture assembly constructed from several polyblocks depicted in FIGS. 1-12.

FIG. 25 is another exemplary hybrid furniture assembly constructed from several polyblocks depicted in FIGS. 1-12.

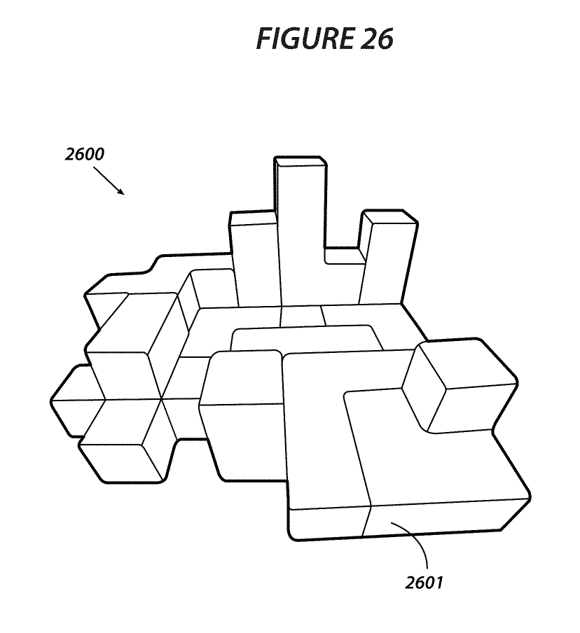

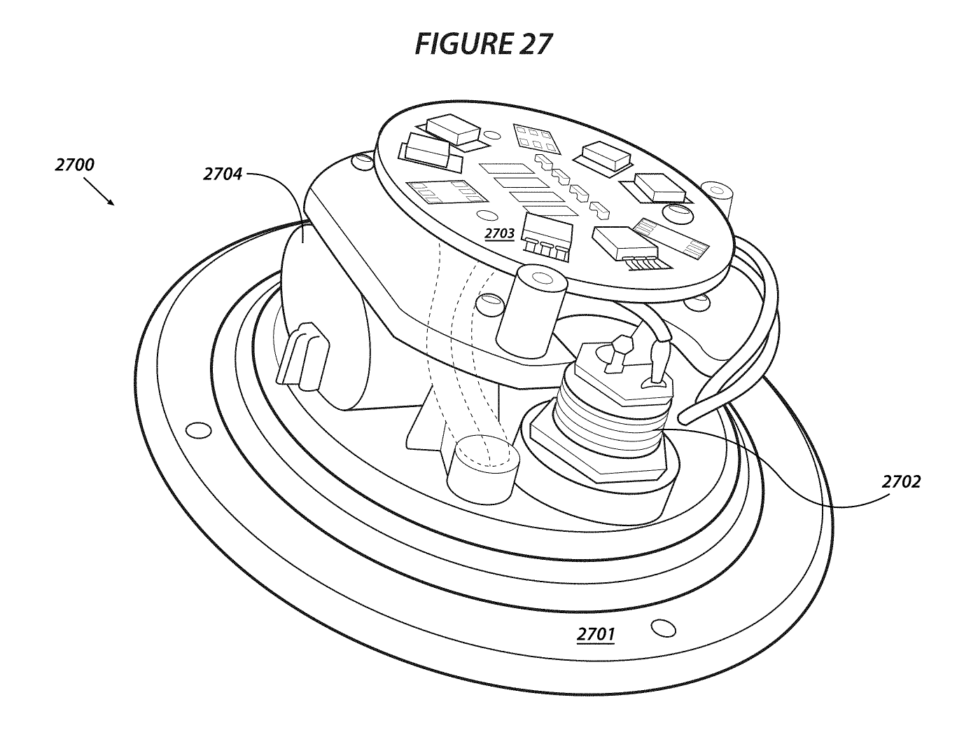

FIG. 26 is yet another exemplary hybrid furniture constructed from several polyblocks depicted in FIGS. 1-12.

FIG. 27 is an exemplary smart hub unit embedded within a polyblock.

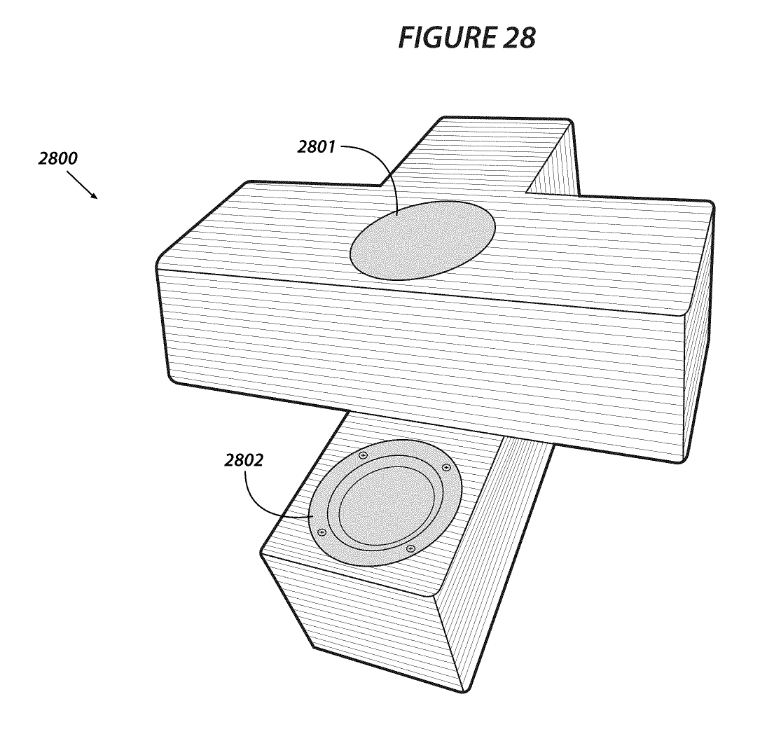

FIG. 28 is a polyblock with exemplary light elements embedded therein.

### DETAILED DESCRIPTION

A detailed description of some embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to some embodiments have not been described in detail to avoid unnecessarily obscuring the description.

Before the present invention is described in detail, it is to be understood that, unless otherwise indicated, this disclosure is not limited to specific procedures or articles, whether described or not.

It is further to be understood that the terminology used herein is for the purpose of describing particular embodiments only and is not intended to limit the scope of the present invention.

It must be noted that as used herein and in the claims, the singular forms “a,” and “the” include plural referents unless the context clearly dictates otherwise.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure. The term “about” generally refers to ±10% of a stated value.

The present invention provides a modular system with a plurality of polyblocks which may be configured to construct one or more objects. In some embodiments, the constructed objects are furniture pieces (e.g., chairs, tables, and couches). Herein, a polyblock may be defined as a cuboid structure that is equally divisible by a whole number (i.e., positive integers) of cubic areas. Although each polyblock is equally divisible by a whole number of cubic areas, each polyblock is a single indivisible structure. Simply put, a polyblock is a single non-configurable indivisible structure which may be assembled with other polyblocks to form functional objects (e.g., furniture pieces).

In some embodiments, the polyblocks are polycubes that are equally divisible by a plurality of identical cubic areas. For example, the polycubes can be divisible by five equally-divisible cubic areas (i.e., a pentacube) or six equally-divisible cubic areas (i.e., a hexacube). As depicted in the figures, a polycube can be asymmetric or symmetric.

The set of polyblocks illustrated in FIGS. 1-12 feature six asymmetric polyblocks and six symmetric polyblocks. However the present invention is not limited thereto. As previously stated, each polyblock is divisible by five or six cubic areas. For example, if a cubic area is defined by N×N×N, each polyblock may be equally divisible by five N×N×N cubic areas or six N×N×N cubic areas. Accordingly, the asymmetric and cuboid nature of the polyblocks enable various configurations to construct a plurality of assemblies.

In some implementations, the modular system is free of an independent coupling means (e.g., magnetic, snap connections, etc.) to assemble one or more constructed objects. As such, the stability of constructed assemblies is caused by the gravitational force applied on each polyblock in addition to frictional force(s) created by neighboring polyblocks. The present invention is however amenable to include a coupling means (e.g., independent coupling means) to couple two or more polyblocks together to provide additional stability.

As the polyblocks may have sufficient weight (e.g., greater than 15 pounds), no additional coupling means is required. For instance, pentacubes can weigh between 20-22 lbs whereas exemplary hexacubes can weigh between 24-26 lbs. Simply put, the weight of the polyblocks and the frictional force(s) created by neighboring polyblocks provide enough stabiliy for each constructed assembly.

In some implementations, an independent coupling means may be added to the polyblocks to provide additional stability to a configured assembly. For example, the independent coupling means may comprise strips of Velcro, snap-locking components, magnets, or any other suitable coupling means. One having ordinary skill in the art may appreciate that the present invention is not limited to those aforementioned examples.

In addition, the polyblocks may comprise cubic areas that are on a top or bottom portion of each other. In FIG. 10, for example, a hexacube is depicted as having one cubic area that has three lateral neighbors and one vertical neighbor.

The polyblocks disclosed herein may comprise any suitable material to facilitate sturdiness for setting things thereon. In some embodiments, the polyblocks may be suitable for sitting thereon. The polyblocks may comprise a plastic material, foam rubber, synthetic foam, or any other suitable material. In some embodiments, the polyblocks comprise a cloth material on an exterior portion. In yet other embodiments, a light element disposed within the polycubes can illuminate an exterior surface of the polyblocks without requiring an independent coupling means. Accordingly, because of the asymmetry of some of the polyblocks within the set, the constructed objects may be coupled together as there may be at least two points of contact for each pair of polycubes within the constructed object.

Notably, a constructed object may consist of neighboring polyblocks with points of contact in two or more locations. Accordingly, when the polyblocks are assembled as a constructed object, the polyblocks may contact each other vertically (one cubic section disposed on top of another) or laterally (one cubic section horizontally disposed by another). The points of contact between neighboring polyblocks provide locations of coupling due to the frictional forces created.

FIG. 13 is an exemplary cubic area of which a polyblock is divisible by according to some embodiments. For example, a pentacube polyblock may be divisible by five equally cubic areas 1301 although each pentacube polyblock is a single indivisible structure. It should be understood by one having ordinary skill in the art that the present invention is not limited to a pentacube or hexacube. A polycube may be equally divisible by less than five cubic areas or greater than six cubic areas and this would still be within the spirit and scope of the present invention.

Additionally, electronic circuitry can be embedded into one or more polyblocks. This electronic circuitry may include, but not limited to, computing processors, wireless circuitry, power circuitry, orientation detection components (e.g., gyroscope), GPS circuitry, Wi-Fi circuitry, etc. In some embodiments, a polyblock can receive a signal to emit a specific lighting effect, color scheme, etc. from an external device.

In some embodiments, each polyblock can receive instructions from an external device (e.g., smartphone) to be positioned in a particular orientation according to a specific object construction. In some implementations, when the polyblock is positioned in the correct orientation, the polyblock outputs a particular effect (e.g., green light) whereas when the polyblock is positioned in an incorrect orientation, the polyblock outputs another effect (e.g., red light).

In some embodiments, at least one cubic area of a polyblock includes a power component to receive power from an external power source. Notably, cubic area 1301 may include a light element which can emanate a unique color or lighting effect therefrom. In some embodiments, each cubic area 1301 emanates the same color or lighting effect whereas in other embodiments, each cubic area 1301 emanates a unique color or lighting effect therefrom.

The polyblocks may be configured and arranged, in part, according to the color of light or lighting effects that emanate from the lighting element of each polyblock. In particular, when the polyblocks are assembled as furniture pieces, the unique color or lighting effect may be taken into account to achieve an overall lighting or color scheme. As such, one can construct furniture or other objects using the present modular system that facilitates a desired feeling to match or influence a particular human emotion.

For example, if one wants to feel a particular emotion, an object may be constructed according to a particular color scheme or lighting effect. For instance, if a person is in a somber mood, such person can assemble polyblocks having certain colors or an overall color scheme which facilitates or enhances one's mood. Moreover, the light elements embedded into each polyblock may change color according to a placement of the polyblock with respect to the other polyblocks within the constructed object. The present invention therefore provides a construction system which allows users to construct objects in a creative manner according to one's mood.

The light elements may provide lighting effects such as blinking. As such, lighting effects may also create or facilitate an aura associated with the constructed object.

In some embodiments, the external surface of one or more polyblocks may include a material that is reactive to light. These materials may be referred to as “smart materials” which have one or more properties that can be significantly changed in a controlled fashion by external stimuli (e.g., stress, temperature, moisture, pH, electric, or magnetic fields). Examples of smart materials are piezoelectric materials, shape-memory alloy materials, magnetostrictive materials, magnetic shape memory alloys material, smart inorganic polymer materials, photomechanical materials, and dielectric elastomer materials.

Moving forward, FIG. 14 illustrates exemplary polyblocks 1401, 1402 with light elements embedded therein. In some embodiments, polyblocks 1401, 1402 are each asymmetric structures with lateral and vertical sections. When assembled, as shown by constructed object 1500 in FIG. 15, the respective lateral and vertical areas of each polyblock 1501, 1502 generate normal and frictional forces against each other. In some embodiments, polyblocks 1501, 1502 may be water-proof. As such, light-embedded polyblocks 1501, 1502 may function as decorative pieces in a swimming pool, Jacuzzi, or the like.

Notably, FIG. 15 further illustrates how the individual polyblocks coupled together as a constructed object have sufficient stability without independent coupling due to the normal and frictional forces generated from the constructed object 1500. Moreover, as many of the polyblocks (within the set) have a protruding cubic dimension (e.g., vertical component), the stability of the constructed object 1500 may be further aided.

FIG. 16 is a constructed square assembly 1600 comprising all of the exemplary polyblocks depicted in FIGS. 1-12. In some embodiments of the present invention, the constructed object is a 64 cuboid square structure. Constructed square assembly 1600 may be a decorative furniture piece. In other implementations, constructed square assembly 1600 may provide ease of shipping the plurality of polyblocks. In addition, the polyblocks may be used for gaming to configure various objects. For example, a game can be played to build constructed object 1600 since it can be configured in various ways.

FIG. 17 is an exemplary bed structure 1700 constructed from several polyblocks depicted in FIGS. 1-12. The exemplary bed structure 1700 uses all of the polyblocks depicted in FIGS. 1-12 except the polyblocks depicted in FIGS. 8 and 10.

FIG. 18 is an exemplary chair 1800 constructed from two of the polyblocks 1801 depicted in FIGS. 1-12. Specifically, the exemplary chair 1800 uses the polyblocks depicted in FIGS. 4 and 9 without an independent coupling means. In the embodiment shown, the polyblocks are assembled in a manner such that they have at least two points of contact. In some embodiments, the chair 1800 may be constructed from polyblocks with specific light elements to create or facilitate a specific mood or aura.

FIG. 19 is an exemplary table 1900 constructed from several polyblocks 1901 depicted in FIGS. 1-12. The exemplary table 1900 is constructed from the polyblocks depicted in FIGS. 1, 2, 6, 10, 11, and 12.

FIG. 20 is an exemplary couch 2000 constructed from several polyblocks 2001 depicted in FIGS. 1-12. The exemplary couch 2000 is constructed from the polyblocks depicted in FIGS. 1, 2, 3, 4, 5, 6, 9, 11, and 12. The couch may be constructed from polyblocks with specific light elements to create or facilitate a specific mood or aura.

FIG. 21 is an exemplary lounge 2100 (or reclining couch) constructed from several polyblocks depicted in FIGS. 1-12. Advantageously, one person can recline on the couch while other persons sit thereon. The lounge or reclining couch 2100 may be constructed from polyblocks 2101 with specific light elements to create or facilitate a specific mood or aura. For example, the polyblocks 2101 chosen for this constructed assembly may be those which facilitate a relaxing mood.

FIG. 22 is an exemplary play structure 2200 constructed from several polyblocks 2201 depicted in FIGS. 1-12. In one or more embodiments, the play structure may be considered a fortress. The play structure 2200 may be constructed from polyblocks 2201 with specific light elements to create or facilitate a specific mood or aura. For example, the polyblocks chosen may be those which create the greatest appeal to children.

FIG. 23 is an exemplary hybrid table 2300 constructed from several polyblocks 2301 depicted in FIGS. 1-12 except the polyblock depicted in FIG. 8. As described above, the exemplary hybrid table 2300 may be constructed from polyblocks 2301 with specific light elements to create or facilitate a specific mood or aura.

Notably, the modular system described herein may be configured such that a change of one or a few polyblocks can create new constructed objects. For example, the assemblies shown in FIGS. 24-26 may be constructed by re-configuring just a single polyblock as will be explained with more detail below.

FIG. 24 is an exemplary hybrid furniture assembly assembly 2400 constructed from several polyblocks depicted in FIGS. 1-7 and 9-12. The hybrid furniture assembly 2400 may be a hybrid divider chair, lounge, and table assembly constructed from the polyblock 2401 depicted in FIGS. 1-12, except the polyblock depicted in FIG. 8. In some embodiments, the hybrid furniture assembly assembly may be constructed from polyblocks 2401 with specific light elements to create or facilitate a specific mood or aura.

FIG. 25 is another exemplary furniture assembly 2500 having an open middle constructed from several polyblocks 2501 depicted in FIGS. 1-12. Notably, the hybrid furniture assembly 2500 displayed in FIG. 25 is constructed by removing polyblock 2402 (see FIG. 24) from area 2504 (of FIG. 25) of hybrid furniture assembly 2500.

The hybrid furniture assembly 2500 is constructed from the polyblocks 2501 depicted in FIGS. 1-12, except the polyblocks depicted in FIGS. 7 and 8. Moreover, the hybrid furniture assembly 2500 may be constructed from polyblocks 2501 with specific light elements to create or facilitate a specific mood or aura.

FIG. 26 is yet another exemplary hybrid furniture assembly 2600 constructed from several polyblocks depicted in FIGS. 1-12. The hybrid furniture assembly 2600 depicted in FIG. 26 is a cross between a loveseat and a lounge. In some embodiments, hybrid furniture assembly 2600 is constructed from the polyblocks depicted in FIGS. 1-12, except the polyblocks depicted in FIGS. 7 and 8. The hybrid furniture assembly 2600 may be constructed from polyblocks 2601 with specific light elements to create or facilitate a relaxing or romantic mood. Notably, the hybrid furniture assembly 2600 displayed in FIG. 26 is constructed by reconfiguring polyblock 2503 (see FIG. 25) into location 2504 (see FIG. 25).

Moving forward, FIG. 27 displays an exemplary smart hub unit. Smart hub unit 2700 can include several electrical components and devices which enable the smart hub unit 2700 to perform various functions. For example, smart hub unit 2700 can include a power unit 2704 (e.g., battery 2704), a lighting element 2702, and communication circuitry hub block 2703 all disposed on a hub substrate 2701 such that a polyblock has sufficient power to generate light and communicate with other polyblocks or external devices.

As known in the art, power unit 2704 may provide power to the smart hub unit 2700 such that said unit 2700 can function. Light element 2702 may function to effect various lighting effects such as, but not limited to, blinking, emitting color, etc. In addition, communication circuitry block 2703 may communicate wirelessly with an external device. For example, communication circuitry block 2703 can communicate with a smartphone device. A smartphone device may be configured with a software application that pairs sets of lighting effects with particular songs. Accordingly, a smartphone can emit instructions to communication circuitry block 2703 to generate a lighting scheme customized for a desired song to thereby facilitate a desired mood.

Moreover, smart hub 27000 may contain wireless charging circuitry such that the polyblock can be easily charged while in contact with a charging pad.

As humans are sensitive to light stimuli constructing assemblies using polyblocks with particular light effects may be a factor in a user's decision in which polyblocks are chosen to build a particular assembly.

FIG. 28 is a polyblock 2800 with exemplary light elements 2801, 2802 embedded therein. As described herein light elements 2801, 2802 can emit light when engaged. In the embodiment shown, polyblock 2800 has two light elements 2801, 2802. However, the present invention is not limited to any particular number of light elements.

The preceding Description and accompanying Drawings describe examples of embodiments in some detail to aid understanding. However, the scope of protection may also include equivalents, permutations, and combinations that are not explicitly described herein. Only the claims appended here (along with those of parent, child, or divisional patents, if any) define the limits of the protected intellectual-property rights.

1. A modular system, comprising:
a plurality of polyblocks capable of being assembled together to construct one or more objects;
wherein each polyblock consists of a single, indivisible unit;
wherein at least one of the polyblocks has an asymmetric shape.

2. The modular system of claim 1, wherein the plurality of polyblocks can be assembled into a square-shaped structure.

3. The modular system of claim 1, wherein at least one polyblock comprises a smart hub unit with embedded electrical circuitry operable to receive instructions regarding the correct orientation of the at least one polyblock for a specific object construction.

4. The modular system of claim 1, wherein the one or more objects to be constructed are at least one of a furniture piece, play structure, performance platform, work surface, or room partition.

5. The modular system of claim 1, wherein each polyblock comprises a light sensitive surface on an exterior portion of each polyblock.

6. The modular system of claim 1, wherein the modular system is without an independent coupling component to assemble the one or more constructed objects.

7. The modular system of claim 1, wherein each polyblock has an asymmetric shape and the one or more objects to be constructed has a symmetric shape.

8. The modular system of claim 1, wherein each polyblock is evenly divisible by five or six cubic dimensions.

9. A modular system, comprising:
a plurality of polycubes capable of being assembled together to construct one or more objects,
wherein each polycube consists of a single, indivisible unit;
wherein at least one of the structures has an asymmetric shape and at least one of the structures has a symmetric shape.

10. The modular system of claim 9, wherein the one or more constructed objects comprises at least two of a table portion, lounge portion, or a couch portion.

11. The modular system of claim 9, wherein the one or more objects comprises a loveseat section and a lounge section.

12. A furniture system, comprising:
a plurality of polycubes capable of being assembled together to construct one or more objects,
wherein each polycube consists of a single, indivisible unit;
wherein each polycube has an asymmetric shape and the one or more constructed objects has a symmetric shape.

13. The furniture system of claim 12, wherein the one or more objects is at least one of a chair, table, or couch.

14. The furniture system of claim 12, wherein at least one polycube includes a lighting element.

15. The furniture system of claim 12, wherein the one or more constructed objects is a hybrid of at least two furniture pieces.

16. A modular system, comprising:
a plurality of polyblocks capable of being assembled together to construct one or more objects;
wherein each polyblock consists of a single, indivisible unit;
wherein at least one of the polyblocks has an asymmetric shape;
a smart hub unit, comprising:
a power assembly;
an orientation component;
a plurality of light elements; and
a communication circuitry block.

17. The modular system of claim 16, wherein the plurality of light elements are operable to emit several lighting elements.

18. The modular system of claim 16, wherein the one or more objects to be constructed are based in part on the light elements embedded.

19. The modular system of claim 16, wherein the plurality of light elements can display two or more colors.

20. The modular system of claim 19, wherein the plurality of light elements coupled to each polyblock can change color according to a placement of the polyblock with respect to another polyblock within the constructed object.
